(19) United States
(12) Patent Application Publication
(10) Pub. No.: US 2009/0185390 A1
(43) Pub. Date: Jul. 23, 2009

(54) EMERGENCY WHEEL LIGHT AND METHOD OF USE THEREOF

(76) Inventor: Ferdinand Alvin Hines, JR., Dallas, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/015,687

(22) Filed: Jan. 17, 2008

(51) Int. Cl. B60Q 7/00

(52) U.S. Cl. 362/546

(57) ABSTRACT

An emergency wheel light located in a protected environment behind an access door when not in use is extractable from under the wheel well or frame/bed of a vehicle to illuminate a wheel for servicing in darkness. The lamp portion, preferably of LED bulbs, is held in a retainer attached to the weatherproof access door or within the vehicle frame/wheel well. A plurality of the lamps is independently selectable for activation, such that any combination of the lamps can be on. To use, the lamp is pulled from its retaining mount and extended on its retractable cord reel into a position where it can be utilized to shine on the wheel servicing area by placing the lamp's flat base for placing the lamp on a ground surface.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to emergency lighting devices, and more specifically to a vehicle emergency light having a lamp located in an enclosure within a wheel well or under a truck bed and extendible therefrom, typically for use when servicing a vehicle wheel.

2. Description of Related Art

During the course of travel in a road vehicle, it is not uncommon for a vehicle tire to become punctured either by road debris and/or through excessive wear.

In order to replace the wheel having the punctured tire with an emergency spare tire, it is necessary for the vehicle operator to remove the existing wheel and reinstall the spare wheel under conditions where visibility is poor due to darkness and/or locations wherein the vehicle operator cannot be readily seen by oncoming traffic. Thus, such attempts to replace a punctured tire with the spare tire are at best difficult and at worst extremely dangerous.

Various attempts have been made to provide fixed emergency lighting for vehicles; however, most of these are directed to providing warnings to oncoming motorists rather than to overcome the unsafe conditions that are often prevalent when changing a tire. Other than such fixed emergency lighting which cannot be readily utilized for changing a tire, it is often necessary for the vehicle operator to utilize a battery-powered lighting device such as a flashlight. Unfortunately, flashlights are often not well maintained, and, accordingly, the batteries therein may have degraded to the point of rendering the flashlight useless.

In order to overcome the problem of a dead flashlight, attempts have been made to provide lighting devices connected to the vehicle main battery supply. Unfortunately, such lighting devices are often not located conveniently for illuminating the work area when changing a tire. Further, such an illuminating device does not readily illuminate more than one wheel area at a time.

Accordingly, devices have been made that are installed in wheel wells or near a wheel of the vehicle. One such device is disposed within the wheel well and is activated by extracting the device from the wheel and extending it on a telescoping bar to a position from which it can shine on the wheel well area. Unfortunately, such devices disposed within the wheel well lack protection from damage and are subject to the harsh environment of water and/or debris being cast off from the wheel, thereby shortening their usable life.

One existing device is a lamp on the end of a fiber optic light guide that derives its light from the side illumination lamps of a vehicle. The device is mounted near the center of the wheel to provide a visually pleasing illumination effect, but does not provide a facility for directing at a work area around and on a wheel to be removed/replaced.

Still another device has extendable housings on the outside of the fender above the wheel well. The housings pull out, switching the lights ‘on’, and the lights derive their power from the main battery of the vehicle. The housings have a light therein that is aimed downward at the wheel well area. While this device can provide reasonable illumination of the wheel area, it cannot be maneuvered to different locations, such as to locate objects lost during servicing.

Yet another device is a light at the end of a rod that is clamped to any available ridge under the frame of a vehicle. The rods are of selected fixed length, limiting the ability to be positioned and the lamp is controlled by the switching of the main lights of the vehicle. The rods further extend outside the dimensions of the vehicle, lending themselves to damage from passing obstructions.

Another previous device is a lamp with a base to hold it upright, and with a retractable coil power cord. The device inserts into the wall of the wheel well and is extracted by pulling on a finger hold. Power is derived from the dash switches of the vehicle. A plastic cube covers the light bulb. While the device claims to be insertable into the wall of the wheel well, the reference does not disclose what it is inserted into and/or how it is retained therein. Although it asserts to be protected from the weather, such is not discernable from the disclosure, and it would appear that only the bulb portion has any protection, thereby rendering the frame of the device open to damage from debris.

Other existing devices, such as the aforementioned flashlights, must be held by a second person, or inconveniently must occupy one of the hands of the person attempting to change the tire.

Therefore, it is readily apparent that there is a need for an emergency wheel light and method of use thereof, wherein the emergency wheel light is readily available at each of the wheels, is protected from damage, and is convenient in its use, such that it does not require the person changing the tire to utilize one of their hands to hold the light at the same time as removing the tire.

### BRIEF SUMMARY OF THE INVENTION

Briefly described, in a preferred embodiment, the present invention overcomes the above-mentioned disadvantages and meets the recognized need for such a device by providing an emergency wheel light and method of use thereof, wherein the lamp portion of the emergency wheel light is located in a protected environment behind an access door. The lamp portion is held in a retainer within a holder in the wheel well or could be held in a similar retainer attached to the access door. Opening the door activates and provides access to the lamp which is then pulled from its retainer and extended into a position where it can be utilized to shine on the wheel servicing area. A retractable cord reel permits the power cord to be extended and retracted. The lamp portion further has a flat base for placing the lamp into a stable disposition on a ground surface, with or without benefit of a stand for support.

The present invention has independently selectable lamps in each wheel well or under the frame or bed of the vehicle proximate the wheels. Each lamp is activated by a combination of a door switch (providing power through the dome light or wired similarly providing power when the vehicle door is open or ajar) and an individual switch on each lamp holder. Thus, all four lamps, or any combination of the lamps, can be on at any time as selected by the vehicle operator.

According to its major aspects and broadly stated, the present invention in its preferred form is an emergency wheel light and method of use thereof, wherein the emergency wheel light has one or more lamps with holders having a retainer dimensioned to securely retain the lamp. The holders are disposed within wheel wells or under the frame of a vehicle close to the vehicle wheels. Each emergency wheel light has a weatherproof door, and the retainer is disposed on the inside of the weatherproof door, or, alternately, is disposed within the holder and covered by the weatherproof door. A switch is disposed on or within the holder and activated by either opening of the door or removal of the lamp from the holder. A cord reel with a retractable cord provides extendibility of the lamp from the wheel well. This permits placement of the lamp in a selected location, where the shape of the lamp retains the lamp in position on a ground surface, and selective aiming of the lamp at the wheel being serviced.

Each lamp has one or more LED bulbs; in particular, one or more high-intensity LED bulbs, and may further include one or more flashing red LED bulbs. Each lamp further has a slidable front lens for access to the bulb or bulbs therewithin.

The lamp is powered from the vehicle battery and selectively receives its power via the dome light switch or similarly wired, thereby permitting the emergency wheel light to be activated when the vehicle door is open. Further, extraction of the lamp from its holder, or opening the weatherproof door covering the lamp, switches the emergency wheel light on.

A vehicle equipped with the present invention has an independently-selectable lamp at each wheel location, such as, for exemplary purposes only, within the wheel well. Each lamp is removably secured in its holder within the wheel well of a vehicle when not in use. A lamp retainer is either incorporated into the holder within the wheel well, or, alternately, on the inside of the weatherproof door.

In use, the vehicle door is opened providing power to the emergency wheel lights and a wheel is illuminated by opening the weatherproof door and extracting the lamp from the holder and/or retainer within the wheel well, thereby activating the lamp. Subsequently, the lamp is extended, unreeling its power cord from its cord reel. The lamp is then placed on a ground surface and aimed at the selected location for servicing the wheel. The shape of the lamp provides a stable base for standing the lamp on the ground surface.

By providing independently operated lamps, each wheel of a vehicle has a lamp close by and only that lamp needs to be activated to provide illumination to a wheel area for service thereof. The apparatus provides illumination without the need for use of a free hand or another person, and further provides visibility of the vehicle and its operator by approaching vehicles.

The weatherproof door keeps water and other debris from causing damage to the emergency wheel light. Opening the door, or extraction of the lamp from its holder and/or retainer, switches the lamp on.

More specifically, the present invention is an emergency wheel light and method of use thereof, wherein the emergency wheel light has a lamp and a holder situated within a wheel well of a vehicle. The holder has an enclosure, a hinge, a door and a retainer, and the door is secured to the enclosure by the hinge. The retainer is disposed on the enclosure and the lamp is slidably disposed behind the retainer and secured by same when not in use.

The lamp has a base, a bulb or bulbs, and a lens that covers and provides access to the bulb or bulbs for changing or replacement. The bulb or bulbs could be, without limitation, incandescent, fluorescent, or a light emitting diode (LED), such as a high intensity LED or a plurality of LEDs, and/or a flashing red LED. The lamp is connected with the dome lamp of the vehicle via an activation switch and a cord. The dome lamp is further connected to, and switched by, the door switch of the vehicle, and the door switch provides power from the vehicle battery. The activation switch is a normally closed pushbutton switch that is held open by the lamp when same is in its retainer, or alternately the activation switch can be disposed on the outside of the retainer, where it is activated by closure of the door. The door is latched in its closed position by a latch and when the door is closed, it exerts pressure on the activation switch, opening same and turning off power to the lamp.

In use, the interior door switch of the vehicle is activated when the vehicle operator exits the vehicle, thereby providing power to the dome light, and consequently to the wheel light. The wheel light enclosure cover, which is weatherproof, is opened and the lamp is removed from its retainer, activating the switch and lighting the lamp. The lamp is extended by pulling its cord which then unreels from a cord reel. The lamp is placed in a suitable location on the ground or other flat location and aimed at the wheel requiring service. The base of the lamp provides stability and permits aiming of the lamp. Alternately, the lamp can be aimed at oncoming traffic to advise same of the presence of the disabled vehicle. When use is concluded, the lamp is returned to its retainer and the door is closed, thereby providing protection from water and or debris, and/or preventing damage to lamp.

If desired, more than one emergency wheel light can be activated at the same time, merely by removal of same from its holder. Such provides quick illumination of all wheel wells and wheels as may be required to identify a mechanical problem.

In an alternate embodiment, the emergency wheel light has its retainer disposed on the weatherproof door. The lamp is stored within the retainer. Closure of the door causes the door to press on the activation switch within the enclosure, maintaining the lamp in ‘off’ condition. As the door is opened, the lamp is activated by the release of pressure on the switch. Opening the door about the hinge provides access to the lamp within the retainer on the door, turning the lamp on, thereby providing easy location of the lamp by the vehicle operator.

In another alternate embodiment of the emergency wheel light, it is installed under the bed of a truck near the wheels. The lamp is then extracted from its holder after opening of the weatherproof door, and the lamp is oriented to illuminate one of the wheels of the truck being serviced.

Accordingly, a feature and advantage of the present invention is its ability to illuminate a vehicle wheel.

Another feature and advantage of the present invention is its ability to provide a warning to oncoming motorists.

Still another feature and advantage of the present invention is its ability to be conveniently disposed without requiring that it be handheld in position.

Yet another feature and advantage of the present invention is its ability to be utilized for either automobiles or trucks.

Yet still another feature and advantage of the present invention is that it is protected from water and debris damage.

A further feature and advantage of the present invention is its ready condition in being powered from the main battery of the vehicle.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a side view of a vehicle depicting a preferred embodiment of the present invention;

FIG. 2 is a side view of a wheel well and wheel of a vehicle showing a preferred embodiment of the present invention;

FIG. 3A is a detail perspective view of a preferred embodiment of the present invention, shown with lamp portion removed from its holder and retainer;

FIG. 3B is a detail perspective view of an alternate embodiment of the present invention, shown with lamp portion within its retainer; and

FIG. 4 is a side view of truck trailer depicting an alternate embodiment of the present invention.

### DETAILED DESCRIPTION OF THE PREFERRED AND SELECTED ALTERNATE EMBODIMENTS OF THE INVENTION

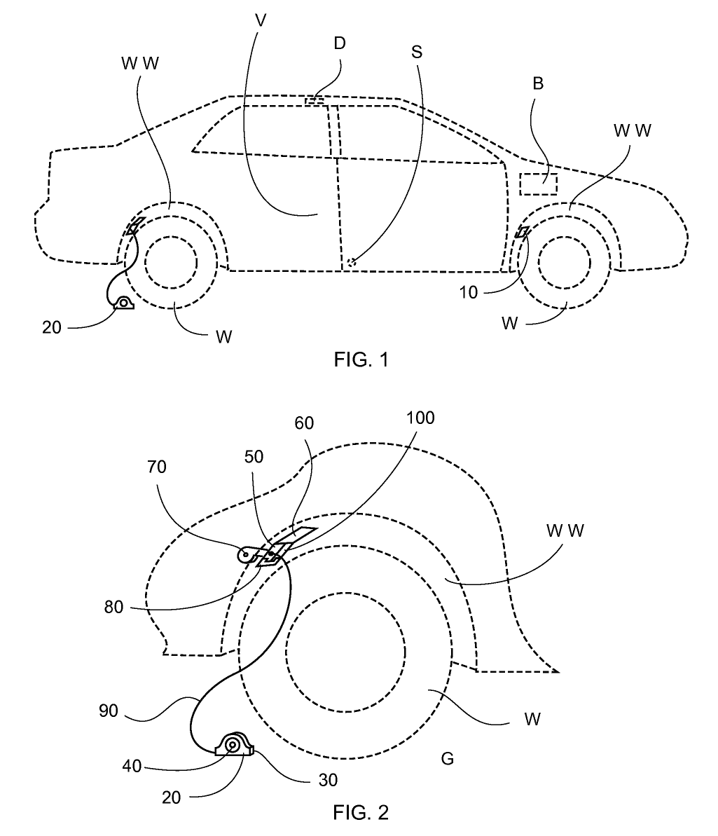

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3A, the present invention in a preferred embodiment is emergency wheel light 10, wherein emergency wheel light 10 comprises lamp 20, and holder 50, wherein holder 50 is situated within wheel well WW of vehicle V. Holder 50 comprises enclosure 100, hinge 120, door 60 and retainer 80, wherein door 60 is hingedly secured to enclosure 100 via hinge 120. Retainer 80 is disposed on enclosure 100, wherein lamp 20 is slidably disposed behind retainer 80 and secured thereby, when not in use.

Lamp 20 comprises base 30, bulb 40 and lens 130, wherein bulb 40 could comprise any lighting source such as is known in the art, including, without limitation, incandescent bulbs, fluorescent bulbs, light emitting diodes (LEDs). In particular, bulb 40 comprises a high intensity LED or a plurality of LEDs, and further could comprise a flashing red LED. Lens 130 is slidably disposed on lamp 20, wherein sliding removal of lens 130 provides access to bulb 40 for changing/replacement thereof.

Lamp 20 is in electrical communication with dome lamp D of vehicle V via switch 110 and cord 90, wherein dome lamp D is in electrical communication with, and switched by, door switch S, and wherein door switch S is in electrical communication with battery B. Switch 110 comprises a normally closed pushbutton switch that is held in the open position by lamp 20 when such is present, or alternately can be disposed on the outside of retainer 80, wherein switch 110 is retained in its open position by closure of door 60. Door 60 is latched in closed position by latch 140, and when door 60 is closed, it exerts pressure on switch 110, opening same and turning off power to lamp 20.

In use, door switch S of vehicle V is activated when the vehicle operator exits vehicle V, thereby providing power to dome light D. Door 60 is opened and lamp 20 is removed from retainer 80, wherein extraction of lamp 20 from retainer 80 activates switch 110, thereby illuminating lamp 20.

Lamp 20 is extended by pulling cord 90 which unreels from cord reel 70. It will be recognized by those skilled in the art that cord reel 70 could comprise any device known for accumulating cords and retaining same in a tight, space-saving configuration.

Lamp 20 is placed in a suitable location on ground G and aimed at wheel W for servicing same, wherein base 30 provides stable placement and orientation of lamp 20. Alternately, lamp 20 can be aimed at oncoming traffic to advise same of presence of disabled vehicle V.

When use is concluded, lamp 20 is returned to retainer 80, and door 60 is closed. In the closed position, door 60 provides protection from water and or debris, preventing same from damaging lamp 20.

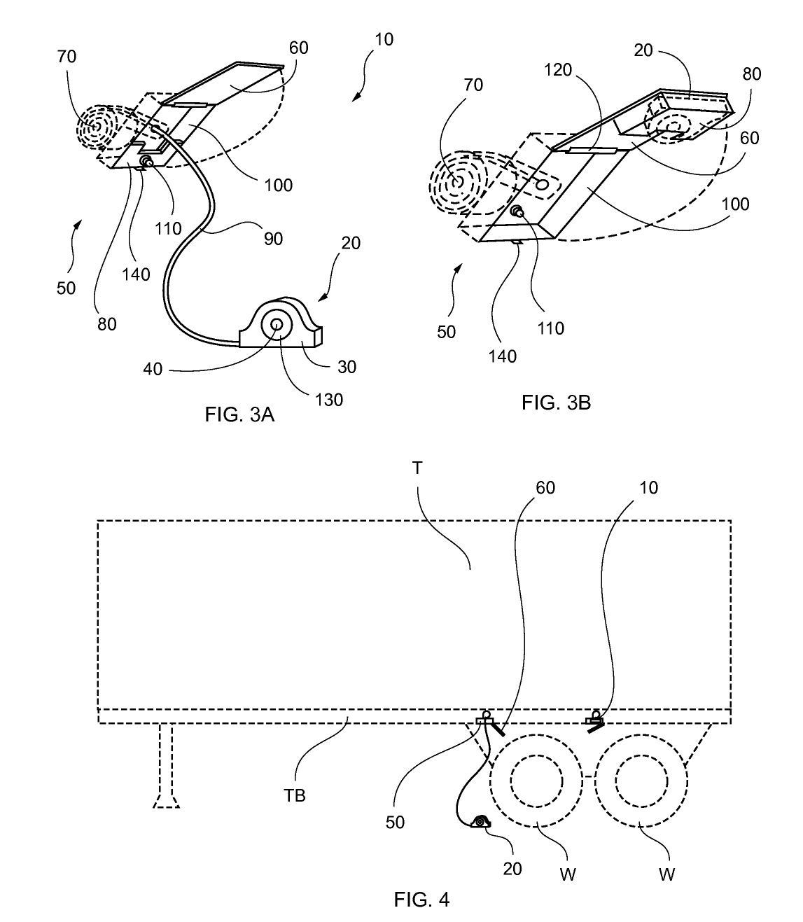

Referring now more specifically to FIG. 3B, illustrated therein is an alternate embodiment of emergency wheel light 10, wherein the alternate embodiment of FIG. 3B is substantially equivalent in form and function to that of the preferred embodiment detailed and illustrated in FIGS. 1-3A except as hereinafter specifically referenced. Specifically, the embodiment of FIG. 3B comprises emergency wheel light 10 having enclosure 100 comprising retainer 80, wherein enclosure 100 comprises switch 110, and wherein retainer 80 is disposed on door 60. Lamp 20 is stored within retainer 80.

It will be recognized that incorporation of switch 110 as in FIG. 3B, such that opening of door 60 causes illumination of lamp 20, will provide easy location of lamp 20 by the vehicle operator.

Opening of door 60 about hinge 120 provides access to lamp 20 within retainer 80 on door 60, wherein lamp 20 is removed to utilize same. As door 60 is opened, lamp 20 is activated by release of pressure on switch 110, wherein switch 110 is a normally closed pushbutton switch in electrical communication with lamp 20 and cord 90 (best shown in FIG. 3A).

Referring now more specifically to FIG. 4, illustrated therein is an alternate embodiment of emergency wheel light 10, wherein the alternate embodiment of FIG. 4 is substantially equivalent in form and function to that of the preferred embodiment detailed and illustrated in FIGS. 1-3A except as hereinafter specifically referenced. Specifically, the embodiment of FIG. 4, comprises emergency wheel light 10 installed under bed TB of truck T proximate wheels W, wherein lamp 20 is extracted from holder 50 after opening of door 60, and wherein lamp 20 is oriented to illuminate one of wheels W being serviced.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An emergency wheel light comprising:
a lamp; and
an enclosed holder disposed proximate a vehicle wheel.

2. The emergency wheel light of claim 1, wherein said holder is disposed within a wheel well of a vehicle.

3. The emergency wheel light of claim 2, wherein said holder comprises a retaining frame.

4. The emergency wheel light of claim 3, wherein said retaining frame is dimensioned to receive and retain said lamp.

5. The emergency wheel light of claim 4, wherein said holder further comprises a weatherproof door.

6. The emergency wheel light of claim 5, wherein said weatherproof door comprises said retaining frame.

7. The emergency wheel light of claim 1, wherein said emergency wheel light further comprises a cord reel.

8. The emergency wheel light of claim 1, wherein said lamp comprises a shape dimensioned and adapted to retain said lamp in a selected fixed location on a ground surface.

9. The emergency wheel light of claim 1, wherein said lamp comprises at least one high-intensity LED bulb.

10. The emergency wheel light of claim 1, wherein said emergency wheel light is powered from a battery of a vehicle.

11. The emergency wheel light of claim 1, wherein said emergency wheel light receives its power from a circuit selected from the group consisting of dome light switch circuitry and similarly-wired circuitry of a vehicle.

12. The emergency wheel light of claim 1, wherein said holder is disposed under the frame of a vehicle.

13. A method of illuminating a vehicle wheel, said method comprising the steps of:
opening a weatherproof door within a wheel well of a vehicle; and
extracting an emergency wheel light from a frame within the wheel well.

14. The method of illuminating a vehicle wheel of claim 13, wherein said emergency wheel light is shaped and dimensioned to be retained upright in a selected disposition on a ground surface, said method further comprising the step of:
extending said emergency wheel light from the wheel well;
aiming said emergency wheel light at a wheel; and
disposing said emergency wheel light on a ground surface.

15. The method of illuminating a vehicle wheel of claim 14, said method further comprising the step of:
powering said emergency wheel light by opening a door of the vehicle.

16. An emergency vehicle light comprising:
at least one independently-selectable lamp having a shape dimensioned and adapted to retain said lamp in a selected fixed location on a ground surface, wherein said at least one lamp is removably secured in at least one holder disposed within said at least one wheel well of a vehicle when not in use; and
a retractable cord.

17. The emergency vehicle light of claim 16, said at least one lamp comprising a slidable front lens, wherein said slidable front lens is removable for access to a bulb therewithin.

18. The emergency vehicle light of claim 17, further comprising a weatherproof door.

19. The emergency vehicle light of claim 18, wherein said at least one holder is disposed on said weatherproof door.

20. The emergency vehicle light of claim 19, further comprising at least one flashing red LED.
